(19) United States
(12) Patent Application Publication
(10) Pub. No.: US 2004/0079180 A1
(43) Pub. Date: Apr. 29, 2004

(54) Machine for converting a rotational motion in one part to a corresponding, but different defined rotational motion in another part or parts

(76) Inventor: Robert Netherton Brown, JR., Frederick, MD (US)

Correspondence Address: Robert N. Brown, 7301 Brookside Drive, Frederick, MD, 21702, US

(21) Appl. No.: 10/277,885

(22) Filed: Oct. 23, 2002

(51) Int. Cl. F16H 35/18

(52) U.S. Cl. 74/10.9

(57) ABSTRACT

A rotational transfer connection mechanism to convert the rotational motion of one shaft to a corresponding, but different defined rotational motion in another shaft. The actuating part of the mechanism attaches to the first shaft and includes an offset tab or pin that fits into an aperture in the second part, which is attached to a second shaft, thus allowing the tab to travel through a portion of its rotation before engaging the second part. The dimensions of the aperature and tab or pin allow the shaft connected to the second part to move only a defined portion of the rotation of the first part.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of mechanical rotation and more specifically to a machine for converting a rotational motion in one part to a corresponding, but different defined rotation in another part or parts to allow different precise rotations of two shafts. To the extent that is will be used to interface mechanical with electrical or electronic devices, it will apply to the electrical, electronic and to the mechanical fields.

There is a lack of mechanical devices that allow the connection of the shafts of different mechanisms in a way that allows for a different rotation in each shaft. Flexible shafts are a prior technology that as a secondary purpose can allow different rotations between shafts, but for applications that demand defined rotations, a flexible shaft is not able to provide a defined movement in each shaft.

This is especially true in using mechanical devices to control electrical devices where the rotation of the second shaft needs to conform to definite tolerances. For instance, in the interface between a mechanical keyed lock and an electronic rotary switch, the switch may only be able to turn a total of 15 degrees while the key lock may be required to turn 90 degrees in order to be able to remove the key in either the on or off position. In this case, the switch actually turns 7½ degrees left or right of a centerline to turn On or Off. To interface these two devices, a device is needed that allows the key lock to rotate 90 degrees, yet only moves the shaft of the electronic switch 7½ degrees clockwise or counter clockwise.

The commercially available flexible shafts do not have adjustable rotational torques and would not be suitable for this application.

This type of application requires a defined and precise rotation of each shaft, which is possible with this invention.

The flexible shaft could be related to this invention in that it is capable of transmitting rotational force from one shaft to another shaft and allowing different rotations for each shaft. This use of the flexible shaft is not economical or feasible today for applications where precise rotation is required in the second shaft, particularly where the either of the two rotations are restricted to definite limitations.

The flexible shaft cannot provide for the precise tolerances required for shaft rotation when interfacing with shafts of electronic parts or in delicate mechanical applications.

### BRIEF SUMMARY OF THE INVENTION

The primary object of the invention is A mechanism to adapt the rotation of one shaft so that it corresponds with and operates a second shaft requiring a different degree of rotation.

Another object of the invention is An inexpensive way to adapt two parts to each other, each of which requires a different rotation for operation.

Another object of the invention is to facilitate the interface of two parts that each have shafts and require precise, but separate degrees of rotation, as is the case in interfacing mechanical components with electrical components.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a device for converting a rotational motion in one part to a corresponding, but different defined rotational motion in another part or parts A rotational transfer connection mechanism comprising: An actuating shaft connection mechanism, which includes a shaft and offset tab or pin that fits into an aperture in the rotational transfer mechanism to the second shaft, allowing the actuating part's tab to travel through a portion of its rotation before engaging the second shaft transfer mechanism and allowing the shaft connected to the second part to move a portion of the rotation of the first part, permitting the two shafts to move in corresponding directions with separate degrees of rotation.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a cross sectional view of the invention.

FIG. 3 is a plan view of the rotational conversion mechanism on the second shaft.

FIG. 4 is a cross sectional view of the rotational conversion mechanism of the invention (Part 10) along the line A—A.

FIG. 5 is a plan view of the actuating shaft mechanism of the invention.

FIG. 6 is a cross sectional view of the actuating shaft mechanism of the invention.

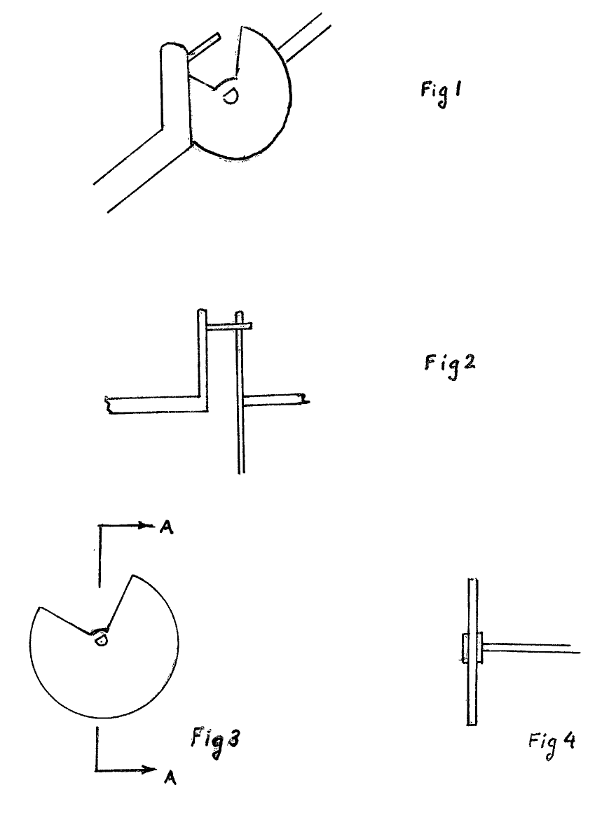

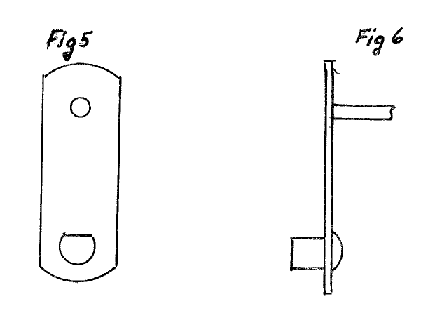

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

### DETAILED DESCRIPTION

A mechanism for converting the rotational motion of one part to a corresponding, but different defined rotation in another part or parts. The device is comprised of two main parts which function as a connection between two shafts or devices: the first is the actuating part which transfers and converts the the rotation from the first part to a different but corresponding rotational movement in the second part. The parts comprising this first actuating part are an offset tab or pin that fits into an aperture in the second part, allowing the tab or pin of the first part to move around the shaft or centerline of the second part and to travel at least through a portion of its full movement before engaging the second part and rotating the second shaft in a corresponding direction. This permits the shafts to be connected and to rotate in similar directions, but with separate degrees of rotational movement, allowing one shaft to transfer a rotational movement in the first part to a specific, but different defined rotational movement in the second part.

The preferred embodiment includes two parts each of which fits onto a separate shaft. The actuating part includes a tab or pin of definite width offset from the centerline of the first shaft which will fit into a slot of predetermined dimension in a disc or portion of a disc that comprises the second part and rotates the second shaft a portion of the first shaft.

An alternate embodiment includes a torque conversion device that will allow the device to move with a “snap action”, and which is comprised of a second plate, which is mounted adjacent to the disc comprising the second part and which includes a bearing to insure that until the defined torque is achieved in the first part, the second part will not transfer the rotation.

The advantages of this invention are that it allows two devices, each of which requires a different rotation to operate, to connect with one another in a way that allows each to operate successfully with the other. In an alternate embodiment, the device allows one device to operate with another with a “snap action”. This can be important in electronic applications for example, where switching must be accomplished quickly to avoid dead spots. Since most break-before-make switches have such a dead space where a switch can be disconnected from one circuit but not yet switched to the second circuit if the actuating mechanism is turned slowly, the invention plus snap action alternate embodiment would insure that the second shaft turns quickly once the required torque is reached and the problem of dead spots is eliminated.

The device also permits the two shafts to turn precisely with different degrees of rotation: so that a 90 degree rotation in the actuating mechanism can be converted to a small rotation of the secondary shaft. On most four-pole three position electronic switches for instance, the rotation required for two position operation is 15 degrees, divided into two parts each 7½ degrees off a centerline. This invention allows such a switch to be operated with an actuating mechanism that requires 90 degrees. A key lock with 90 degree rotation can be used to interface with an electronic switch that operates with a rotation of 7½ degrees on each side of center. Since most keylocks require either a 90 or 180 degree rotation before the key can be removed in either position, this allows the keylock to have a removable key in either position when interfaced with a four-pole, three position electronic rotary switch, which is locked off at two positions.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A device for converting a rotational motion in one part to a corresponding, but different defined rotational motion in another part or parts comprising:
A connection mechanism, one actuating part of which includes a shaft and offset tab or pin that fits into an aperture in the second part; allowing the tab to travel through a portion of its rotation before engaging the second part, allowing the shaft connected to the second part to move a portion of the rotation of the first part; and
A rotational transfer connection mechanism comprised of at least two main parts which permits two shafts to move in corresponding directions with separate degrees of rotation.
